(19) United States
(12) Patent Application Publication
(10) Pub. No.: US 2014/0229271 A1
(43) Pub. Date: Aug. 14, 2014

(54) SYSTEM AND METHOD TO ANALYZE AND RATE ONLINE ADVERTISEMENT PLACEMENT QUALITY AND POTENTIAL VALUE

(71) Applicant: VINDICO LLC, Irvine, CA (US)

(72) Inventors: Christophe L. Clapp, Corona, CA (US); Brian C. DeFrancesco, Trabuco Canyon, CA (US)

(73) Assignee: VINDICO LLC, Irvine, CA (US)

(21) Appl. No.: 14/177,507

(22) Filed: Feb. 11, 2014

Related U.S. Application Data
(60) Provisional application No. 61/763,236, filed on Feb. 11, 2013.

(51) Int. Cl. G06Q 30/02

(52) U.S. Cl. CPC G06Q 30/0245
USPC 705/14.44

(57) ABSTRACT

A method, apparatus, system, article of manufacture, and computer program product provide the ability to rate advertisement placement quality. First data is collected from a panel of opt-in users. The first data is information about advertisement exposure and first web pages visited. A system of web crawlers are used to visit and render second web pages in a web browser to extract web crawling data. The web crawling data is information about advertisement placement in the second web pages. The first data is processed and aggregated with the web crawling data. Based on the aggregated first data and web crawling data, an ad placement quality rating is computed.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/763,236, filed on Feb. 11, 2013, by Christophe L. Clapp and Brian C. DeFrancesco, entitled “System and Methodology to Analyze and Rate Online Advertisement Placement Quality and Potential Value” attorneys' docket number 257.74-US-P1.

This application is related to the following co-pending and commonly-assigned patent application, which application is incorporated by reference herein:

U.S. patent application Ser. No. ______, filed on the same date herewith, by Christophe L. Clapp and Brian C. DeFrancesco, entitled “COMPREHENSIVE MEASUREMENT OF THE OPPORTUNITY TO SEE ONLINE ADVERTISEMENTS,” attorneys' docket number 257.72-US-U1, which application claims priority to Provisional Application Ser. No. 61/763,226, filed on Feb. 11, 2013, by Christophe L. Clapp and Brian C. DeFrancesco, entitled “Comprehensive Measurement of the Opportunity to See Online Advertisements (“Viewability”),” attorneys' docket number 257.72-US-P1.

### BACKGROUND OF THE INVENTION

1. Field of the Invention

The present invention relates generally to online advertisements, and in particular, to a method, apparatus, and article of manufacture for comprehensively analyzing and rating the potential value of online advertisement placement(s) on websites for brand advertisers.

2. Description of the Related Art

Online (Internet) advertisements have become ubiquitous and synonymous with browsing the Internet (on both traditional desktop computers as well as mobile browsing platforms such as cellular devices, tablets, etc.) and mobile applications (“apps”). Often times, advertising is the primary revenue source for a website and/or app. The valuation of an advertisement may vary depending on the location of the advertisement, the demographic the advertisement is presented to, and other factors.

Web site owners desire to maximize the revenue received from advertisers. Similarly, advertisers desire to obtain the highest percentage return/yield for their advertisement expenditures. Accordingly, it is desirable to analyze and rate the online advertisement placement quality and potential value. Prior art systems fail to provide an acceptable system for both rating an advertisement's placement quality as well as the potential value of the advertisement. These problems may be better understood with an explanation of prior art online advertising.

Online (Internet) advertising consists mainly of banner ads (rich media formats or images) and video ads.

More brand advertisers than ever are turning to Internet advertising to engage with consumers. The Internet provides an efficient and effective way for them to reach target audiences in masses. However, online advertisement also presents complex problems with respect to transparency and differentiation of ad placements. With print advertising, for example, a brand advertiser and their agency can easily pick up a magazine and see that their advertisement ran where and how it was agreed to in a contract. The Internet, however, is incredibly fragmented, with attention spread across millions of sites. This has led to an automated system of ad placement that is not fully transparent and commoditizes ad placements, with many ad platforms not capable of fully showing advertisers where and how their ads were shown to consumers.

FIG. 1 illustrates the ad delivery ecosystem prior to 2008. Generally speaking, prior to 2008, the ad delivery ecosystem was composed mainly of direct advertiser 102 to publisher (website) 104 ad buys with some ads being delivered through third party ad servers 106 and potentially resold by a limited number of ad networks 108. The majority of ads were booked directly with publishers 104, and ad networks 108 were only given access to remnant (unsold) inventory.

Since 2008, the online advertising industry's growth and mounting potential has attracted hundreds of companies to enter the space. FIG. 2 illustrates the ad delivery ecosystem around 2010. Providing services for advanced optimization, yield management, behavioral targeting, real time bidding, and streamlined operations, the deep integration of new businesses and channel intermediaries has significantly impacted the ad delivery ecosystem. However, they have also contributed to the complexity of the ad delivery ecosystem.

The main reason for the increase in intermediaries has been a fundamental change from site specific ad placement buying to programmatic audience buying across almost any website 104 providing access to their inventory through an exchange 202, supply side platform 204, or ad network 206 (e.g., network and demand side platform). This fundamental shift in the way ad placements are purchased for advertisers 102 has put distance between the publisher (website) 104 and advertisers 102 as illustrated in FIG. 3.

FIG. 3 illustrates a more recent online ad ecosystem of the prior art. The various ecosystems may be used to describe the evolution of online advertising. Originally (as depicted in FIGS. 1 and 3), the advertiser (or agency of the advertiser) 302 directly bought ad space (referred to as ad inventory) on a website of a website owner/publisher 304. The inventory was in the form of ad impressions (see definition below). As the number of websites increased, ad space on the websites 304 exceeded the purchased ads leaving a large number of unpurchased inventory. Consequently, ad networks 306 evolved and acted as a sales broker, purchasing the ad inventory and selling packaged inventory onto the buyer 302 thereby making it easier for the buyer 302 to target specific consumers. Multiple ad networks 306 resulted with each network 306 using different technology and systems. Advertisers 302 often utilized multiple ad networks 306 resulting in the targeting, presentation, and purchase of the same consumer/audience more than once.

Ad exchanges 308 evolved and provided the ability for advertisers to trade audiences instead of inventory. Sellers/publishers 304 offered their audience on the exchange 308, and purchasers 302 could purchase the audience (after which ads were delivered to the purchased audience). As a result, advertising could be purchased via both ad networks 306 and ad exchanges 308. To improve the sale and purchase of ads and increase efficiency, various agencies 302 created their own proprietary agency trading desks (ATD) 310 or demand side platforms (DSP) 312. ATD 310 and/or DSP 312 provided the ability for the agencies 302 to trade on the ad exchange 308 efficiently and in real time (using data to influence their decision making) Some publishers 304 sell directly on the exchange 308 while other publishers 304 invested in sell side platforms (SSP) 314 that optimizes selling points for the publisher 304.

One of the side effects of the current ecosystem is that publisher ad impressions (“inventory”) is often commoditized with the inventory of millions of other websites without the inventory buyer 302 (advertiser or agency on their behalf) fully knowing where and how the inventory is sourced. Without placement transparency, the main differentiator of value is only “audience” (the user's interest and behaviors) targeting.

Online video advertising has even more complexity and lack of transparency due to the nature of how ads are delivered on publisher websites 304 through video players. Often video players can be daisy chained to other video players and/or ad rendering players causing increased transparency complexity due to technical limitation in the player having access to the website DOM (see definition below).

In the modern ecosystem, it's common for an ad impression to pass through multiple platforms before an ad is ultimately selected and displayed to a user. This environment wouldn't be problematic for marketers if each intermediary was a transparent layer in the ad delivery chain. However, advertisers 302 have a limited ability to access placement data due to cross domain or nested IFrames, video ad players with access restrictions to the webpage DOM, and other information access limited by the same origin policy.

When ad placement environments are unknown, fair value cannot be given to buying and selling ad impressions because there is no clear differentiation between ad placements on what would be considered high value websites and those on low quality, low value websites or within fraudulent environments.

The reality of an ecosystem where billions of impressions are sold, traded, redirected, and resold through many channels every second with partial transparency is that fraud and low quality, low value ad delivery can occur with minimal detection. These non-compliant impressions range from inaccuracy in placement to rogue parties intentionally running ads on pornographic websites or hiding impressions from appearing at all.

Below is a list and brief description of some of the most common malpractices and low quality placement environments:

URL Padding: advertisers buy inventory spanning many sites; however, impressions are delivered only on a small, low quality subset of the sites.

Geolocation & Day Parting: impressions are served outside of a targeted zone (internationally or blatantly outside of a targeted region) or during non-approved hours of the day.

Below the Fold: impressions are served below the visible area of a webpage and may never be scrolled into the view of the webpage visitor.

Publisher Tag Misplacement: a legitimate publisher signs up to work with an advertising party and runs very few or none of the ads on his or her legitimate site. Ad tags are usually placed inside a cross-domain iFrame residing on the legitimate publisher's servers so that the ads appear to be running on the legitimate site while they are instead sold across exchanges, or placed directly on non-approved sites.

Ad Refresh/Rotation: impressions rotate quickly within a single ad window during a single page view.

Ad Stuffing/Stacking: multiple ad tags are nested/hidden within one ad window where only one ad is visible to the user.

Invisible Pages: hidden iFrames, often with multiple layers of nesting, loading multiple pages/sites with ads concealed from a user's view. These are often used in conjunction with affiliate and traffic exchange programs.

Bots and Auto-surfs: impressions and clicks are generated as intentional fraud by either humans who are paid or non-human, mechanized systems.

Invisible Ad-Size: An ad container element's size is set too small for the ad to be visible (example: iFrame or div with Opx width or Opx height). These are commonly referred to as “1×1”, “hidden”, or “invisible” iFrames.

Invisible Ad-Hidden: An ad container element's CSS property for visibility or display is set so that the ad will not be visible to the user (example: “display=none” or “visibility=hidden”).

Invisible Ad-Position: The ad is positioned outside of the viewable window and there are no scrollbars to scroll the ad into view. This includes ads that are positioned off the positive viewable area of the page/window (example: position “top=−10000 px” or position “left=−10000 px;”).

Page Refresh or Redirected: Page that automatically refreshes or redirects in a short period of time.

Video In-Banner (autoplay): Video ad automatically plays (muted) outside of any video content stream and typically inside a display ad container.

Disposable Video Player: Video ad automatically plays in a disposable player that was solely used to play the ad outside of any video content stream and then is removed from the page.

XML HTTP Request: Ad is requested via an XMLHttpRequest and is not loaded onto the DOM of the webpage. The impression may be counted by the ad server and additional tracking pixels may or may not be rendered.

### SUMMARY OF THE INVENTION

Embodiments of the invention provide a system and methodology for comprehensively analyzing and rating the potential value of online advertisement placement(s) on websites for brand advertisers using an all-inclusive set of quality metrics.

### BRIEF DESCRIPTION OF THE DRAWINGS

Referring now to the drawings in which like reference numbers represent corresponding parts throughout:

FIG. 1 illustrates the ad delivery ecosystem prior to 2008;

FIG. 2 illustrates the ad delivery ecosystem around 2010;

FIG. 3 illustrates an online ad ecosystem of the prior art;

FIG. 4 is an exemplary hardware and software environment used to implement one or more embodiments of the invention;

FIG. 5 schematically illustrates a typical distributed computer system using a network to connect client computers to server computers in accordance with one or more embodiments of the invention; and

FIG. 6 illustrates the logical flow for rating advertisement placement quality in accordance with one or more embodiments of the invention.

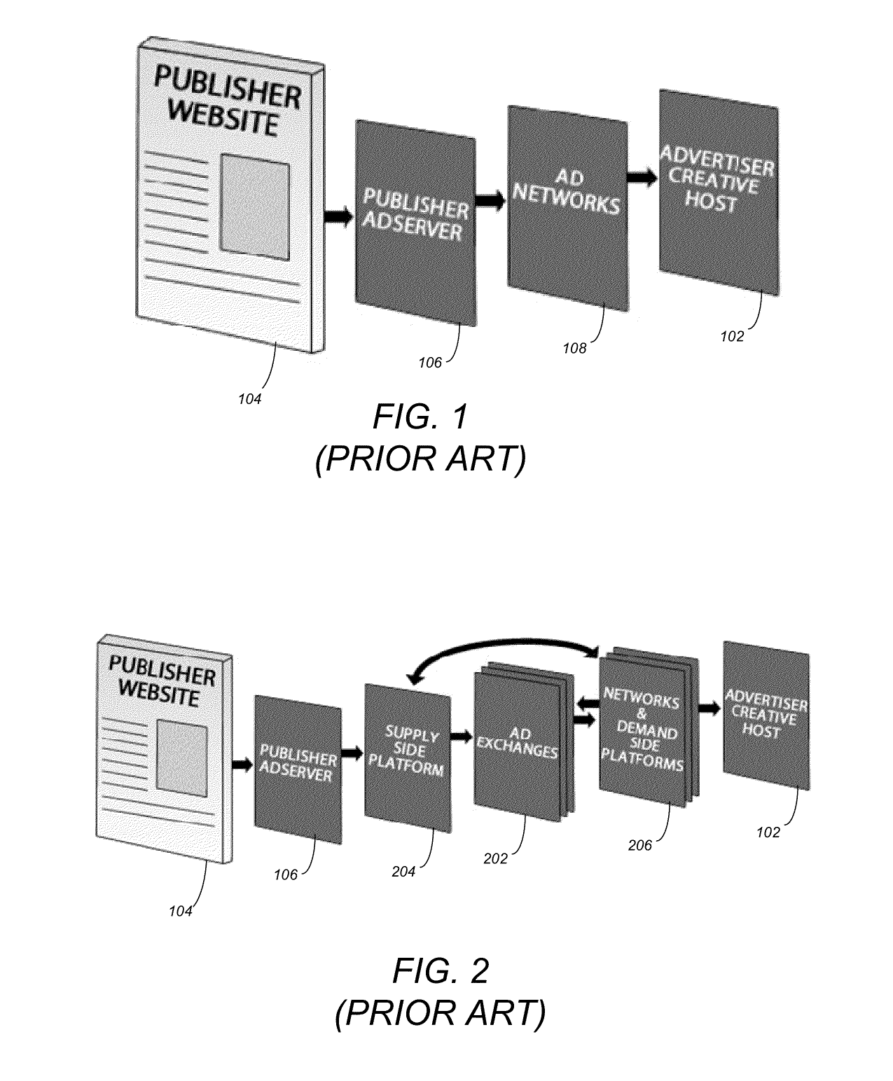

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention comprehensively analyze and rate the potential value of online advertisement placement(s) on websites for advertisers using an all-inclusive set of quality metrics. Information is gathered from an opt-in panel of web browsing users and combined/aggregated with information from a system of geographically diverse web crawlers that gather automatically (i.e., independently from and without user interaction) information from various websites (e.g., including the same or some of the same websites visited by the web browsing users). The aggregated data is used to analyze and rank ad placements on the webpages. Such ratings may be organized/produced based on various categories and/or for an overall (e.g., comprehensive) quality rating for a particular publisher/website.

### DEFINITIONS

Online Panel

A group of Internet users who represent a larger portion of all Internet users and allow for their online activity to be tracked and aggregated to create statistically significant projections for the entire population of users.

Panelist

An active and real (non-automated) Internet user who has enabled and allowed anonymous monitoring and capturing of their online activity.

Browser

Short for web browser, a software application used to locate, retrieve and also display content on the World Wide Web, including webpages, images, video and other files. As a client/server model, the browser is the client run on a computer that contacts the Web server and requests information. The web server sends the information back to the web browser which displays the results on the computer or other Internet-enabled device that supports a browser. Popular examples include: Mozilla's Firefox™, Microsoft's Internet Explorer™, Google's Chrome™, Apple's Safari™.

App

An “app” is application software that causes a computer to perform useful tasks. A mobile app is software designed to run on smartphones, tablet computers, and other mobile devices. As used herein, an app refers to both mobile and non-mobile based apps.

API

Acronym for “Application Program Interface,” though it is sometimes referred to as an “Application Programming Interface.” An API is a set of commands, functions, and protocols that programmers can use when building software for a specific system. The API allows programmers to access and use predefined functions to interact with the system, instead of writing them from scratch. For browser extensions, browser API's enable and allow extensions to interact with the browser.

URL

Acronym for “Uniform Resource Locator.” A URL is the address of a specific web site or file on the Internet. URLs often provide a specific character string that constitutes a reference to a resource (e.g., web site or file). URLs are commonly used for web pages (http:) but can also be used for file transfer (ftp:), email, telephone numbers, and many other applications.

Website

A set of interconnected webpages, usually including a homepage, generally located on the same server, and prepared and maintained as a collection of information by a person, group, or organization.

Webpage

A document on the World Wide Web, consisting of an HTML file and any related files for scripts and graphics, and often hyperlinked to other documents on the Web. The content of webpages is normally accessed by using a browser.

Hypertext Transfer Protocol (HTTP)

The Hypertext Transfer Protocol provides a standard for Web browsers and servers to communicate. HTTP is an application layer network protocol built on top of TCP (transmission control protocol). HTTP clients (such as web browsers) and servers communicate via HTTP request and response messages.

Crawler

A web crawler is an automated program, or script, that methodically scans or “crawls” through Internet pages (with or without a browser) to create an index of the data it is looking for. There are various uses for web crawlers, but essentially a web crawler may be used by anyone seeking to collect information out on the Internet. Search engines frequently use web crawlers to collect information about what is available on public web pages.

Document Object Model (DOM)

The Document Object Model (DOM) is a cross-platform and language-independent convention for representing and interacting with objects in HTML, XHTML (extensible hypertext markup language) and XML (extensible markup language) documents. The Document Object Model allows for programs and scripts to dynamically access and update the content, structure and style of documents.

Cascading Style Sheets (CSS)

Cascading Style Sheets (CSS) is a style sheet language used for describing the presentation semantics (the look and formatting) of a document written in a markup language. Its most common application is to style web pages written in HTML and XHTML, but the language can also be applied to any kind of XML document, including plain XML, SVG (scalable vector graphics) and XUL (XML user interface language).

JavaScript™ (client/“browser” side)

JavaScript™ (sometimes abbreviated as JS) is a scripting language commonly implemented as part of a web browser in order to create enhanced user interfaces and dynamic websites. Javascript™ can interact with HTML source code, enabling Web authors to enhance their sites with dynamic content.

Same Origin Policy (SOP)

In computing, the same origin policy is an important security concept for a number of browser-side programming languages, such as JavaScript™. The policy permits scripts running on pages originating from the same site (a combination of scheme, hostname, and port number) to access each other's methods and properties with no specific restrictions, but prevents access to most methods and properties across pages on different sites.

IFrame

IFrame are independent HTML documents within a webpage that limit access between the frame content and the page loading the frame. While IFrame are important for protecting private user data and scaling websites, they can put up a virtual ‘firewall’ from page level access when they are not from the same origin as the webpage.

Cross Domain IFrame

A cross domain inline frame (iframe) is a type of web technology that can be used to embed a small portion of one website within a larger “parent” page hosted on a different domain. An iframe containing content from an external site, such as a social networking or video sharing service, can easily be placed on a webpage to add new features or boost interactivity.

Nested IFrame

When one or more IFrames are contained inside another IFrame, this is referred to as a nested IFrame. In online advertising, as multiple intermediaries using IFrames for ad delivery enter the ad delivery process, IFrames collect in deeper and deeper nests, causing transparency and complexity in knowing where and how an ad is ultimately displayed because of limited webpage access due to the same origin policy. This makes it particularly challenging for advertisers as they are positioned at the end of the delivery process.

Ad Impression (Impression)

An ad impression, sometimes called a view or an ad view, is a term that refers to the point in which an ad is viewed once by a visitor, or displayed once on a web page.

Ad Network

An online advertising network or ad network is a company that connects advertisers to web sites that want to host advertisements. The key function of an ad network is aggregation of ad space supply from publishers and matching it with advertiser demand. The phrase “ad network” by itself is media-neutral in the sense that there can be a “Television Ad Network” or a “Print Ad Network,” but is increasingly used to mean “online ad network” as the effect of aggregation of publisher ad space and sale to advertisers is most commonly seen in the online space. The fundamental difference between traditional media ad networks and online ad networks is that online ad networks use a central ad server to deliver advertisements to consumers, which enables targeting, tracking and reporting of impressions in ways not possible with analog media alternatives.

Ad Exchange

Ad exchanges are technology platforms that facilitate the auction based buying and selling of online media advertising inventory from multiple ad parties. The approach is technology-driven as opposed to the historical approach of negotiating price on media inventory.

Real Time Bidding

Real-time bidding (RTB) is a relatively new method of selling and buying online advertising in real time one ad impression at a time.

Behavioral Targeting (“Audience Targeting”)

The practice of targeting and serving ads to groups of people who exhibit similarities not only in their location, gender or age, but also in how they act and react in their online environment. Behaviors tracked and targeted include web site topic areas they frequently visit or subscribe to; subjects or content or shopping categories for which they have registered, profiled themselves or requested automatic updates and information, etc.

### Hardware Environment

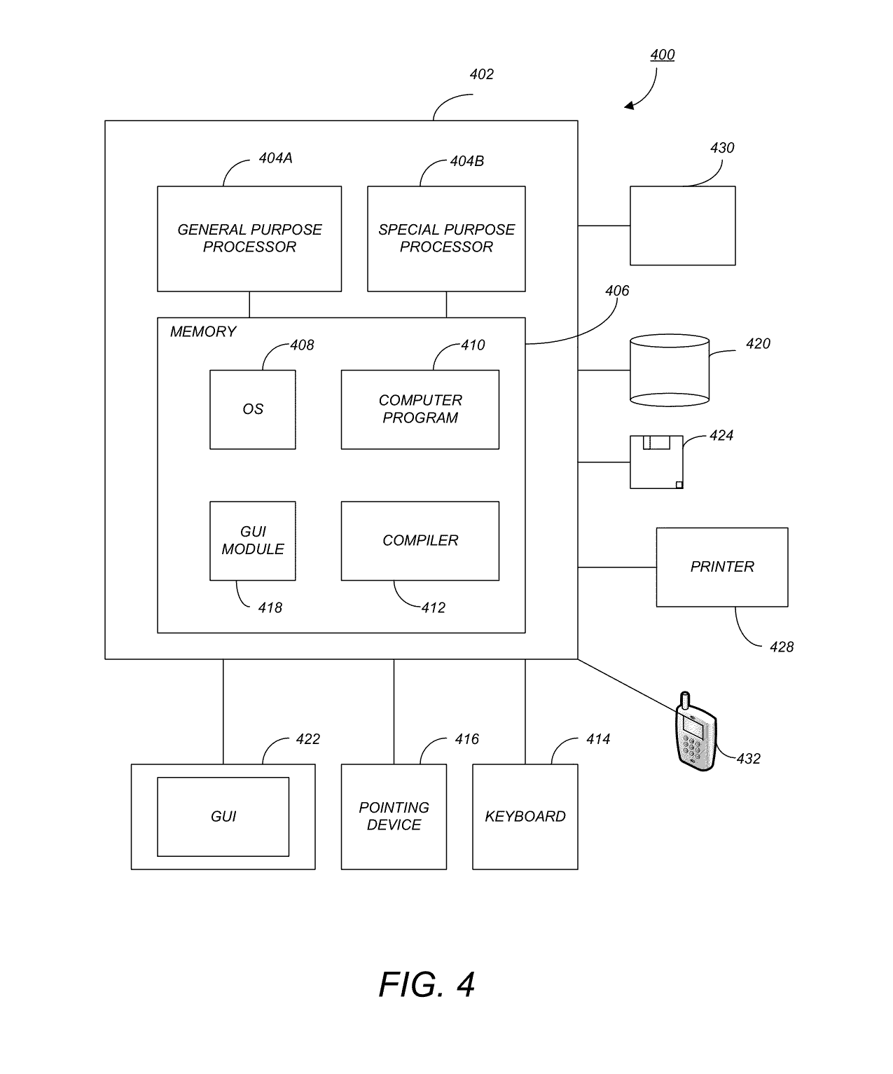

FIG. 4 is an exemplary hardware and software environment 400 used to implement one or more embodiments of the invention. The hardware and software environment includes a computer 402 and may include peripherals. Computer 402 may be a user/client computer, server computer, or may be a database computer. The computer 402 comprises a general purpose hardware processor 404A and/or a special purpose hardware processor 404B (hereinafter alternatively collectively referred to as processor 404) and a memory 406, such as random access memory (RAM). The computer 402 may be coupled to, and/or integrated with, other devices, including input/output (I/O) devices such as a keyboard 414, a cursor control device 416 (e.g., a mouse, a pointing device, pen and tablet, touch screen, multi-touch device, etc.) and a printer 428. In one or more embodiments, computer 402 may be coupled to, or may comprise, a portable or media viewing/listening device 432 (e.g., an MP3 player, iPod™, Nook™, portable digital video player, cellular device, personal digital assistant, etc.). In yet another embodiment, the computer 402 may comprise a multi-touch device, mobile phone, gaming system, internet enabled television, television set top box, or other internet enabled device executing on various platforms and operating systems.

In one embodiment, the computer 402 operates by the general purpose processor 404A performing instructions defined by the computer program 410 under control of an operating system 408. The computer program 410 and/or the operating system 408 may be stored in the memory 406 and may interface with the user and/or other devices to accept input and commands and, based on such input and commands and the instructions defined by the computer program 410 and operating system 408, to provide output and results.

Output/results may be presented on the display 422 or provided to another device for presentation or further processing or action. In one embodiment, the display 422 comprises a liquid crystal display (LCD) having a plurality of separately addressable liquid crystals. Alternatively, the display 422 may comprise a light emitting diode (LED) display having clusters of red, green and blue diodes driven together to form full-color pixels. Each liquid crystal or pixel of the display 422 changes to an opaque or translucent state to form a part of the image on the display in response to the data or information generated by the processor 404 from the application of the instructions of the computer program 410 and/or operating system 408 to the input and commands. The image may be provided through a graphical user interface (GUI) module 418. Although the GUI module 418 is depicted as a separate module, the instructions performing the GUI functions can be resident or distributed in the operating system 408, the computer program 410, or implemented with special purpose memory and processors.

In one or more embodiments, the display 422 is integrated with/into the computer 402 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 402 according to the computer program 410 instructions may be implemented in a special purpose processor 404B. In this embodiment, the some or all of the computer program 410 instructions may be implemented via firmware instructions stored in a read only memory (ROM), a programmable read only memory (PROM) or flash memory within the special purpose processor 404B or in memory 406. Alternatively, computer program 410 may be an app or mobile app that is retrieved via a network and installed on the computer 400. The special purpose processor 404B may also be hardwired through circuit design to perform some or all of the operations to implement the present invention. Further, the special purpose processor 404B may be a hybrid processor, which includes dedicated circuitry for performing a subset of functions, and other circuits for performing more general functions such as responding to computer program 410 instructions. In one embodiment, the special purpose processor 404B is an application specific integrated circuit (ASIC).

The computer 402 may also implement a compiler 412 that allows an application or computer program 410 written in a programming language such as COBOL, Pascal, C++, FORTRAN, or other language to be translated into processor 404 readable code. Alternatively, the compiler 412 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 410 accesses and manipulates data accepted from I/O devices and stored in the memory 406 of the computer 402 using the relationships and logic that were generated using the compiler 412.

The computer 402 also optionally comprises an external communication device such as a modem, satellite link, Ethernet card, or other device for accepting input from, and providing output to, other computers 402.

In one embodiment, instructions implementing the operating system 408, the computer program 410, and the compiler 412 are tangibly embodied in a non-transient computer-readable medium, e.g., data storage device 420, which could include one or more fixed or removable data storage devices, such as a zip drive, floppy disc drive 424, hard drive, CD-ROM drive, tape drive, etc. Further, the operating system 408 and the computer program 410 are comprised of computer program 410 instructions which, when accessed, read and executed by the computer 402, cause the computer 402 to perform the steps necessary to implement and/or use the present invention or to load the program of instructions into a memory 406, thus creating a special purpose data structure causing the computer 402 to operate as a specially programmed computer executing the method steps described herein. Computer program 410 and/or operating instructions may also be tangibly embodied in memory 406 and/or data communications devices 430, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 402.

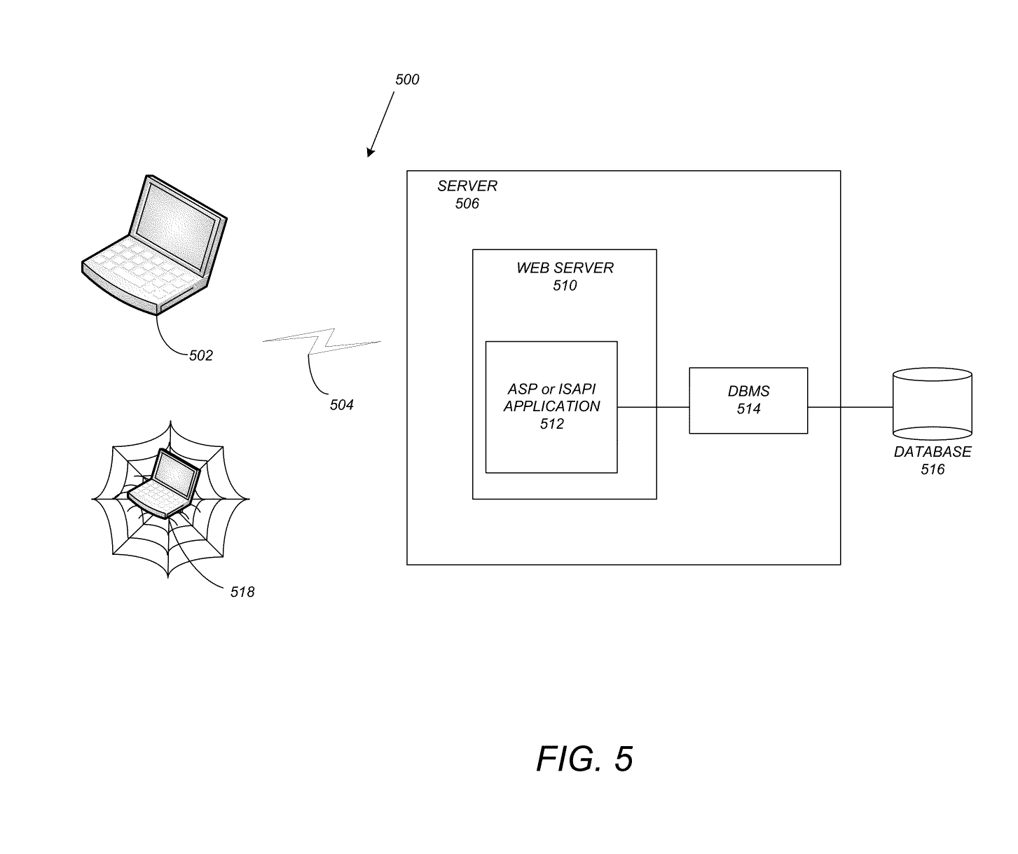

FIG. 5 schematically illustrates a typical distributed computer system 500 using a network 504 to connect client computers 502 to server computers 506. A typical combination of resources may include a network 504 comprising the Internet, LANs (local area networks), WANs (wide area networks), SNA (systems network architecture) networks, or the like, clients 502 that are personal computers or workstations (as set forth in FIG. 4), and servers 506 that are personal computers, workstations, minicomputers, or mainframes (as set forth in FIG. 4). However, it may be noted that different networks such as a cellular network (e.g., GSM [global system for mobile communications] or otherwise), a satellite based network, or any other type of network may be used to connect clients 502 and servers 506 in accordance with embodiments of the invention.

A network 504 such as the Internet connects clients 502 to server computers 506. Network 504 may utilize ethernet, coaxial cable, wireless communications, radio frequency (RF), etc. to connect and provide the communication between clients 502 and servers 506. Clients 502 may execute a client application, app, mobile app, or web browser and communicate with server computers 506 executing web servers 510. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 502 may be downloaded from server computer 506 to client computers 502 and installed as a plug-in or ACTIVEX™ control of a web browser or as an app/mobile app. Accordingly, clients 502 may utilize ACTIVEX™ components/component object model (COM) or distributed COM (DCOM) components to provide a user interface on a display of client 502. The web server 510 is typically a program such as MICROSOFT'S INTERNET INFORMATION SERVER™

Web server 510 may host an Active Server Page (ASP) or Internet Server Application Programming Interface (ISAPI) application 512, which may be executing scripts. The scripts invoke objects that execute business logic (referred to as business objects). The business objects then manipulate data in database 516 through a database management system (DBMS) 514. Alternatively, database 516 may be part of, or connected directly to, client 502 instead of communicating/obtaining the information from database 516 across network 504. When a developer encapsulates the business functionality into objects, the system may be referred to as a component object model (COM) system. Accordingly, the scripts executing on web server 510 (and/or application 512) invoke COM objects that implement the business logic. Further, server 506 may utilize MICROSOFT'S™ Transaction Server (MTS) to access required data stored in database 516 via an interface such as ADO (Active Data Objects), OLE DB (Object Linking and Embedding DataBase), or ODBC (Open DataBase Connectivity).

Generally, these components 500-516 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 502 and 506 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 502 and 506.

### Software Embodiment Overview

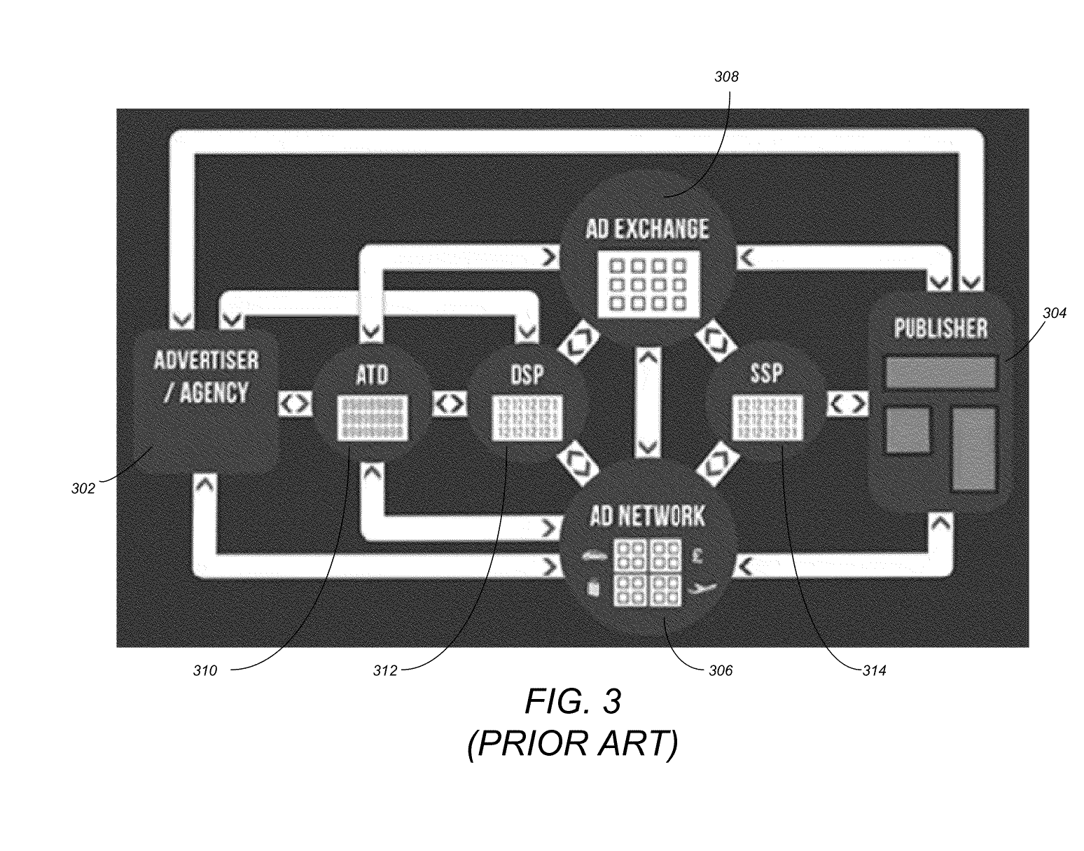

Embodiments of the invention are implemented as a software application on a client 502 or server computer 506. Further, as described above, the client 502 or server computer 506 may comprise a thin client device or a portable device that has a multi-touch-based display. In addition, the configuration set forth in FIG. 3 may also be used to buy/sell and provide/deliver advertisements from advertiser 302 to a publisher/server 304/506 to an end user 502.

Embodiments of the invention comprehensively evaluate the quality of ad placements to provide ratings for ad inventory that guide buying, selling, and valuing of online ad impressions.

The methodology for creating publicly observed ad placement quality ratings combines data collected from a panel of opt-in web users (e.g., clients 502) who have their ad exposure and site visitation activity (e.g., on websites hosted/served by web server 510) anonymously recorded and data collected from a geographically diverse system of web crawlers 518 that render webpages in a popular browser (e.g., on websites hosted/served by web servers 510) and analyze the ad placements on the webpage. The panel of opt-in web users 502 and web crawlers 518 may be controlled/provided by advertiser/agencies 302 or by ad exchanges 308, ad networks 306, and/or other services/entities utilized to provide a service to advertisers/agencies to ensure/advise such advertisers/agencies regarding the web based advertising. For example, such a rating service may be used as part of an audit to ensure advertisers are receiving the advertising they purchased (specified in a contract).

### Panel

Embodiments of the invention are able to identify, capture, and collect data from real users that include, but are not limited to:

Website and Webpage Visitation: Webpage and website visitation is captured by monitoring browser API events indicating a webpage has loaded in a window/tab. For example, in Google Chrome™ this could be monitored using the Chrome browser API chrome.webNavigation.onCommitted.

Browser Window Environment: Browser window data is captured by leveraging the browser extension to access each window object through browser APIs (e.g., Google Chrome's™ content scripts). Window characteristics including the window that opened it (window.opener), status bar (address bar) visibility, size, and menu bar visibility can be used to determine if a window has characteristics of a pop-up/pop-under. Furthermore, this can be combined with data indicating how the window was opened (link, bookmark, or other use initiated action) obtained from browser APIs (e.g., from Google Chrome's™ chrome.webNavigation.onCommitted (specifically transitionType)).

Browser Redirects: By using browser API events for when navigation to a webpage starts and when the completed event occurs, the system is able to know if a webpage is redirected. For example, in Google Chrome™, this could be accomplished using chrome.webNavigation.onBeforeNavigate and chrome.webNavigation.onCommitted. Automated or script based redirection, such as redirects via client side Javascript™ by replacing the window/document location, is captured by the lack of a user event (such as a click) preceding the webpage loading in an existing browser window/tab.

Clickjacking: By leveraging browser extension APIs for accessing events to indicate how a webpage was opened (e.g., using Google Chrome's™ chrome.webNavigation.onCommitted (specifically transitionType), and content scripts to monitor the window's document elements and their css style properties) the system is able to monitor where clicks originate from and if they are the result of a non-intentional event.

Active Window/Tab: Whether a window/tab displaying a webpage becomes active (in focus amongst all browser's windows/tabs) and for how long is captured by using browser API events indicating the window/tab has focus and is active. For example, in Google Chrome™ this could be monitored using chrome.tabs.onActivated. The browser extension code can set a timer to start and stop when a tab is active to track the duration the webpage is potentially viewable to the user.

Online Advertisement and Media/Content Exposure: The browser extension is able to capture all HTTP request activity generated by the browser. This is done via browser extension APIs. For example, in Google Chrome™, this could be monitored using chrome.webRequest.onCompleted.

By examining each HTTP webrequest, advertisements and media can be found using the following methodology:

(1) Check if hostname of HTTP webrequest is for a commonly used advertising or specific media domain such as Google's™ ad sever (e.g., doubleclick.net);

(2) Examine the HTTP webrequest and/or response to confirm it contains an advertisement or media file based on content type, size, and other identifying factors;

(3) Collect and group potential advertisements and media files and have a team of humans validate and identify the brand/advertiser promoted by each ad and verify the media file; and

(4) Store human classifications of advertisements and media files so subsequent human review of similar files can be automated and aggregate activity for each confirmed advertisement or media file. In addition, the advertisements/media files may be indexed or a fingerprint may be stored for them along with the classification. Thereafter, instead of manually validating advertisements/media files, the process may be automated by determining a footprint for an advertisement/media file and searching a database containing categorized advertisements/media files for a match. If a match is found, no further categorization/classification is necessary. If a match is not found, it may be forwarded for manual validation/identification.

The advertisement and content data is coupled with data relating to the window/tab responsible for a webrequest including the webpage and frame that initiated the webrequest. This data is used to calculate quality ratings for ad placements and for guiding the system of web crawlers by creating a queue of webpages to examine.

### Crawlers

A system of highly sophisticated crawlers visit and render webpages in a popular browser (mimicking a real user) to analyze how ads deliver to users there.

The crawling system is designed to deconstruct and thoroughly examine each webpage looking for fraud, low quality or low value environments, and data pertinent to content and ad placement analysis.

The crawling system extracts data points that include but are not limited to:
Page Height
Page Width
Total Requests
Total Media Requests
Page Render Time
Content Length (text)
Content Language (text)
   Profanity total unique words and total count
   Pornography total unique words and total count
   Hate/Violence total unique words and total count
Image Sample (random images for nudity detection processing)
Number of Ad spots on Page
Ads to Content Ratio (number of ads on page/content length)
Position (x,y coordinates) of each Ad
Ad sizes
Ad Asset (.jpg, .gif, .swf, etc)
Number of IFrames Ad delivered through
Iframe Delivery Chain (each iframe involved in serving the ad)
Element Styles of ad parent elements on all frames involved in serving ad (can be used to check if CSS properties to hide ad such as display:none or visibility:hidden or iframes sized 1×1, etc are present):
   Element ID
   Element Name
   Element Type
   Visibility (computed)
   Display (computed)
   Height
   Width
   Offset Position
   Z-Index
   Position
   Overflow
   Opacity
Time ad is on page
Player Size (video)
Player Position (video)
VPAID (video player ad interface definition) or VAST (video ad serving template) Delivery (video)
   VPAID defines a common interface between video players and ad units, enabling a rich interactive in-stream ad experience.
   VAST is an XML schema for serving ads to digital video players, and describes expected video player behavior when executing VAST-formatted responses.
Video Delivery Chain (each SWF in the referrer chain from a player on a page to a final VPAID SWF)
Video player time and rendering on DOM (was video ad played over non-video content)
Element Styles of all SWF and parent elements on all frames involved in serving ad:
   Element ID
   Element Name
   Element Type
   Visibility (computed)
   Display (computed)
   Height
   Width
   Offset Position
   Z-Index
   Position
   Overflow
   Opacity
Video media file that played (.mp4, .flv, etc)
Popups/Pop Under present
Page redirected after loading and where redirected
Page embedding another site in iframe
Meta Refresh present on Page or in Ad Iframe Chain
Meta Refresh Time
Screenshot after set crawl time
Screenshot 5 seconds after each video ad starts to play
Landing Page of Advertisers for Ads found on page
Log containing every HTTP Request and Response during page rendering
   Request URL
   Request Headers
   Response Headers
   Response
   Request Type (media, html/css/js, font, etc)

The crawler captures this data through:

(1) Programmatic access to the web browser which allows for automating webpage navigation, the ability to take screenshots of the webpage and monitor for events such as webpage redirection; and

Setting up a local proxy for all HTTP requests from the browser that is used to analyze all webpage HTTP requests/responses and modify any HTML request's response to include an extra JavaScript file capable of executing and examining each HTML document frame and sending back data for further processing and analysis.

### Rating

After collecting a statistically significant amount of data from multiple examinations of multiple webpages of a website through crawling and panel monitored activity, this data is processed and aggregated to compute ad placement quality category ratings and an overall (comprehensive) ad quality rating for Publishers (websites). The category ratings can include, but are not limited to viewability, content, ad execution, and traffic and domain.

Category Ratings

Viewability: A rating based on the probability of ads having an opportunity to be seen (OTS) by users. This includes position of ad on page, active time users spend on the page, the browser window or tab being in focus among all other browser windows and tabs that are open.

Content: A rating based on the general content topics and page context where ads are present, including detection of vulgar, inappropriate, hate language, the amount of advertising to the amount of content, and the presence of content obstructions (overlays, popups, redirects).

Ad Execution: A rating based on the observed delivery environment of ads. This includes metrics for transparency (iframes, script access), ad rendering, video player size, page load times.

Traffic and Domain: A rating based on the aggregate publishers' trust level (domain registration data, time online, malware rating) and traffic quality (time/engagement on site, referring sites, detection of forced visits from popups, redirection, or embedded pages).

Rating Calculation

The ratings can be calculated on a numeric scale (ex. 1 through 100) or letter based “grading” scale (such as A through F with the option of “+” and “−” letter grades).

The ratings may be calculated by first computing an industry average for each metric from placements that are free from major fraud. The system uses these averages to determine the threshold for an average (for example a “C”) rating. All other ratings are based on deviation from the average. Once a final category rating is calculated, any confirmed incidents are deducted from the final grade based on their level of occurrence.

F: The observed ad placements failed to meet acceptable levels of quality measurement and incident activity.

D: The observed ad placements were below standard industry quality and incident tolerance thresholds.

C: The observed ad placements rank near the industry average for quality metrics and incident activity.

B: The observed ad placements rank slightly above the industry average for ad placement quality metrics and incident activity.

A: The observed ad placements rank higher than the industry average for ad placement quality metrics and incident activity.

An overall rating is calculated based on the category ratings and the weight each contributes to the overall rating.

For publishers, this enables quality, transparent sites to get a higher rating and potential value assigned to their inventory, which likely leads to more ad revenue for them to continue to produce great content. Bad publishers are eliminated or their margins are reduced, forcing them to work on improving their site and ad placement quality which benefits the whole ecosystem.

### Non-Public “Pixel” Based Ratings

For brand advertisers and agencies representing advertisers, publisher quality ratings can also be applied across ad campaigns to understand the value a platform or delivery partner is providing. To cross from the realm of publicly observed ratings to advertiser or campaign specific ratings, a “pixel” technology is utilized. The “pixel” technology is a JavaScript™ based solution which falls back on delivering an image asset when JavaScript™ cannot be executed and is included with every ad impression for the advertiser and/or campaign. The JavaScript™ is responsible for collecting execution data specifically relating to the advertiser's ads as they deliver on publisher websites during an online ad campaign. The “pixel” may be placed within the ad hierarchically on the DOM, or outside of the ad DOM element. The “pixel” is responsible for collecting quality metrics that are submitted back to measurement system over the network. Such quality metrics can include information on the ad size, portion of the ad in view, time in view, ad exposure time, user interaction with the ad and page content, type of browser or device being used on the client, any referrer or domain information involved in the serving of the ad, and others. User interaction can comprise click information, mouse movement, mouse “dwell” time, mouse position, scrolling activity, and others. Page content information can be gathered by analyzing the DOM and sending some DOM information over the network to the measurement system.

This multiplatform approach works to identify where ads deliver, how they deliver, and then determine how much they deliver in each environment. This data is used and compared against industry averages to calculate advertiser or campaign specific quality ratings and can be customized by an advertiser based on specific quality requirements for a brand.

This information can be used by advertiser and agencies to rate and understand placement quality, value, and rank among platforms, websites, and distribution partners and to set and secure thresholds for acceptable quality levels before and during ad campaigns, ultimately assisting to secure and increase return on investment.

### Logical Flow

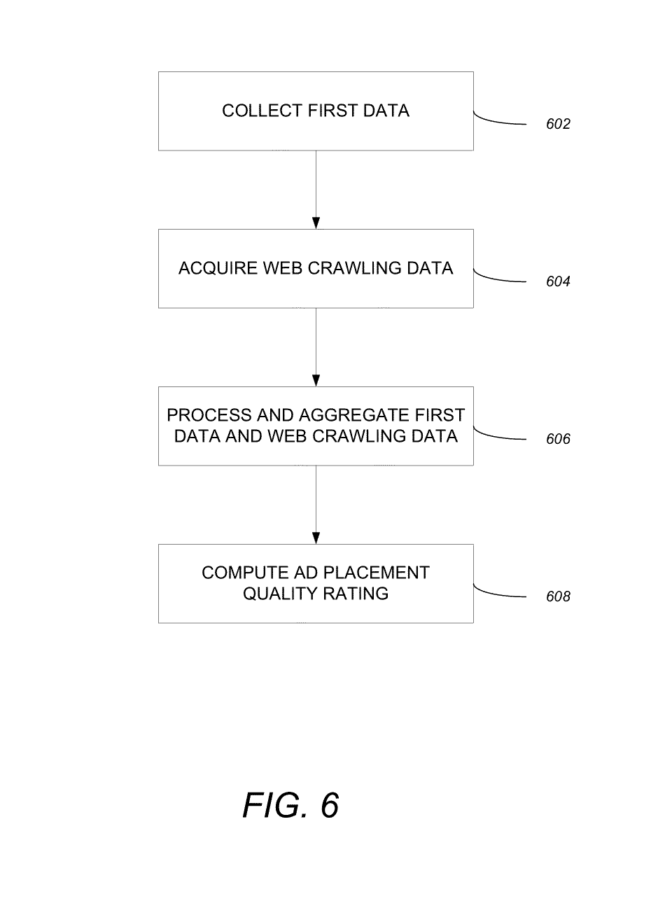

FIG. 6 illustrates the logical flow for rating advertisement placement quality in accordance with one or more embodiments of the invention.

At step 602, first data is collected from a panel of opt-in users. The first data is information about advertisement exposure and one or more first web pages visited. As described above, the first data may include but is not limited to browser window environment information, information regarding whether navigation to a webpage is redirected to another webpage, a determination if a webpage is opened as a result of a non-intentional event, and/or information regarding whether a window or tab displaying a web page is active and a length of time the window or tab displaying the web page is active. The first data may be collected by capturing all hypertext transfer protocol (HTTP) request activity generated by a browser, locating an advertisement or media file (based on the HTTP request activity), and validating and identifying an advertiser promoted by each advertisement and media file. The advertisement or media file may be located by determining whether a hostname of the HTTP request is for a commonly used advertising or media domain, and confirming the HTTP request or response to the request contains the advertisement or media file based on content type, and size.

The first data may be used to create a queue of one or more of the first web pages. Such a queue may define the one or more second web pages that the web crawler will visit (i.e., the first data is used to guide the system of web crawlers by creating a queue of web pages to examine).

At step 604, using a system of one or more web crawlers, one or more second web pages visited and rendered in a web browser. This process extracts web crawling data that consists of information about advertisement placement in the one or more second web pages. The web crawling data is extracted by programmatically accessing the web browser and setting up/using a local proxy to perform various actions. More specifically, to programmatically extract the web crawling data, the web browser automatically (i.e., without additional user input) navigates web pages, captures screenshots of the web pages, and monitors for events (e.g., webpage redirection). The local proxy is set up for all requests from the browser. The local proxy analyzes all requests and responses, and modifies any request's response to include a file. Such a file executes and examines each frame of a web page to acquire proxy data that is transmitted/sent back for further processing/analysis.

At step 606, the first data is processed and aggregated with the web crawling data.

At step 608, based on the aggregated first data and web crawling data, an ad placement quality rating is computed. The ad placement quality rating may be a category rating and/or an overall ad quality rating for a publisher. Categories for which ratings may be computed include viewability, content, ad execution, and traffic and domain. The ad placement quality rating may be calculated/computed by calculating an industry average rating, and calculating specific ad placement quality ratings based on deviation from the industry average rating. Further, as described above, the ratings may be calculated on a numeric scale (e.g., 1 through 100) or a letter based grading scale (e.g., A through F).

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for rating advertisement placement quality, comprising:
collecting first data from a panel of opt-in users, wherein the first data comprises information about advertisement exposure and one or more first web pages visited;
using a system of one or more web crawlers, visiting and rendering one or more second web pages in a web browser to extract web crawling data, wherein the web crawling data comprises information about advertisement placement in the one or more second web pages;
processing and aggregating the first data with the web crawling data; and
based on the aggregated first data and web crawling data, computing an ad placement quality rating.

2. The computer-implemented method of claim 1, wherein the first data comprises browser window environment information.

3. The computer-implemented method of claim 1, wherein the first data comprises information regarding whether navigation to a webpage is redirected to another webpage.

4. The computer-implemented method of claim 1, wherein the first data comprises a determination if a webpage is opened as a result of a non-intentional event.

5. The computer-implemented method of claim 1, wherein the first data comprises:
information regarding whether a window or tab displaying a web page is active; and
a length of time the window or tab displaying the web page is active.

6. The computer-implemented method of claim 1, wherein collecting the first data comprises:
capturing all hypertext transfer protocol (HTTP) request activity generated by a browser;
based on the HTTP request activity, locating an advertisement or media file by:
determining whether a hostname of the HTTP request is for a commonly used advertising or media domain;
confirming the HTTP request or response to the request contains the advertisement or media file based on content type, and size; and
validating and identifying an advertiser promoted by each advertisement and media file.

7. The computer-implemented method of claim 1, further comprising:
utilizing the first data to create a queue of one or more of the first web pages, wherein the queue defines the one or more second web pages.

8. The computer-implemented method of claim 1, wherein the web crawling data is extracted by:
programmatically accessing the web browser, wherein the web browser:
automatically navigates web pages;
captures screenshots of the web pages; and
monitors for events; and
setting up a local proxy for all requests from the browser, wherein the local proxy:
analyzes all requests and responses;
modifies any request's response to include a file, wherein the file executes and examines each frame of a web page to acquire proxy data that is transmitted.

9. The computer-implemented method of claim 1, wherein the ad placement quality rating comprises a category rating.

10. The computer-implemented method of claim 1, wherein the ad placement quality rating comprises an overall ad quality rating for a publisher.

11. The computer-implemented method of claim 1, wherein the ad placement quality rating is calculated by:
calculating an industry average rating; and
calculating specific ad placement quality ratings based on deviation from the industry average rating.

12. The computer-implemented method of claim 1, wherein the ad placement quality rating comprises a letter based grading.

13. An apparatus for rating advertisement placement quality, in a computer system comprising:
(a) a computer having a memory;
(b) an application executing on the computer, wherein the application is configured to:
collect first data from a panel of opt-in users, wherein the first data comprises information about advertisement exposure and one or more first web pages visited;
use a system of one or more web crawlers, visiting and rendering one or more second web pages in a web browser to extract web crawling data, wherein the web crawling data comprises information about advertisement placement in the one or more second web pages;
process and aggregate the first data with the web crawling data; and
based on the aggregated first data and web crawling data, compute an ad placement quality rating.

14. The apparatus of claim 13, wherein the first data comprises browser window environment information.

15. The apparatus of claim 13, wherein the first data comprises information regarding whether navigation to a webpage is redirected to another webpage.

16. The apparatus of claim 13, wherein the first data comprises a determination if a webpage is opened as a result of a non-intentional event.

17. The apparatus of claim 13, wherein the first data comprises:
information regarding whether a window or tab displaying a web page is active; and
a length of time the window or tab displaying the web page is active.

18. The apparatus of claim 13, wherein the first data is collected by:
capturing all hypertext transfer protocol (HTTP) request activity generated by a browser;
based on the HTTP request activity, locating an advertisement or media file by:
determining whether a hostname of the HTTP request is for a commonly used advertising or media domain;
confirming the HTTP request or response to the request contains the advertisement or media file based on content type, and size; and
validating and identifying an advertiser promoted by each advertisement and media file.

19. The apparatus of claim 13, wherein the application is further configured to:
utilize the first data to create a queue of one or more of the first web pages, wherein the queue defines the one or more second web pages.

20. The apparatus of claim 13, wherein the web crawling data is extracted by:
programmatically accessing the web browser, wherein the web browser:
automatically navigates web pages;
captures screenshots of the web pages; and
monitors for events; and
setting up a local proxy for all requests from the browser, wherein the local proxy:
analyzes all requests and responses;
modifies any request's response to include a file, wherein the file executes and examines each frame of a web page to acquire proxy data that is transmitted.

21. The apparatus of claim 13, wherein the ad placement quality rating comprises a category rating.

22. The apparatus of claim 13, wherein the ad placement quality rating comprises an overall ad quality rating for a publisher.

23. The apparatus of claim 13, wherein the ad placement quality rating is calculated by:
calculating an industry average rating; and
calculating specific ad placement quality ratings based on deviation from the industry average rating.

24. The apparatus of claim 13, wherein the ad placement quality rating comprises a letter based grading.
